(19) United States
(12) Patent Application Publication
(10) Pub. No.: US 2007/0042328 A1
(43) Pub. Date: Feb. 22, 2007

(54) Dual Coupling Link for Rubber Band Sculptures

(76) Inventor: Steven Matthew Read, Missoula, MT (US)

Correspondence Address: CHARLES L. READ, 1285 OAK GROVE AVE., STE. 3, BURLINGAME, CA, 94010-3749, US

(21) Appl. No.: 11/161,317

(22) Filed: Jul. 29, 2005

(51) Int. Cl. G09B 11/00

(52) U.S. Cl. 434/82

(57) ABSTRACT

A dual coupling link for rubber band sculptures comprises four rubber bands that are bound together in such a way that the resulting structure contains six coupling loops. By use of said loops, the dual coupling link for rubber band sculptures may be joined to similar links to form a virtually infinite variety of rubber band sculptures.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

Ser. No. 11/105,744 is an application for a toy construction link for rubber band sculptures. The present invention describes how two such links may be interconnected in order to form an extended or dual coupling link.

Ser. No. 29/215,307 is an application for an ornamental design that is constructed, in part, by employing the mechanism described in the present invention.

### STATEMENT OF FEDERALLY SPONSORED RESEARCH OR DEVELOPMENT

Not Applicable.

### REFERENCE TO SEQUENCE LISTING, TABLE, OR COMPUTER PROGRAM

Not Applicable.

### BACKGROUND OF THE INVENTION

Many toy and craft kits contain articles that are fit together to make something that is larger than its constituent pieces. Such kits inspire creativity, develop tactile skills, and encourage focused engagement. The present invention serves a similar purpose by providing a key mechanism used in the construction of a variety of designs wholly made from common rubber bands.

### BRIEF DESCRIPTION OF THE DRAWINGS

FIG. 1 is a front elevational view of the dual coupling link for rubber band sculptures;

FIG. 2 is a bottom plan view thereof;

FIG. 3 is a top plan view thereof;

FIG. 4 is a left side view thereof; the right side view thereof is a mirror image of the left side view thereof;

FIG. 5 is a rear elevational view thereof;

FIG. 6 is a front and bottom perspective view thereof;

FIG. 7 is a rear and bottom perspective view thereof;

FIG. 8 is a rear and top perspective view thereof;

FIG. 9 is a rear and right side perspective view thereof; the rear and left side perspective view thereof is a mirror image of the rear and right side perspective view thereof;

FIG. 10 is a front and right side perspective view thereof; the front and left side perspective view thereof is a mirror image of the front and right side perspective view thereof;

FIG. 11 is a front and top perspective view thereof.

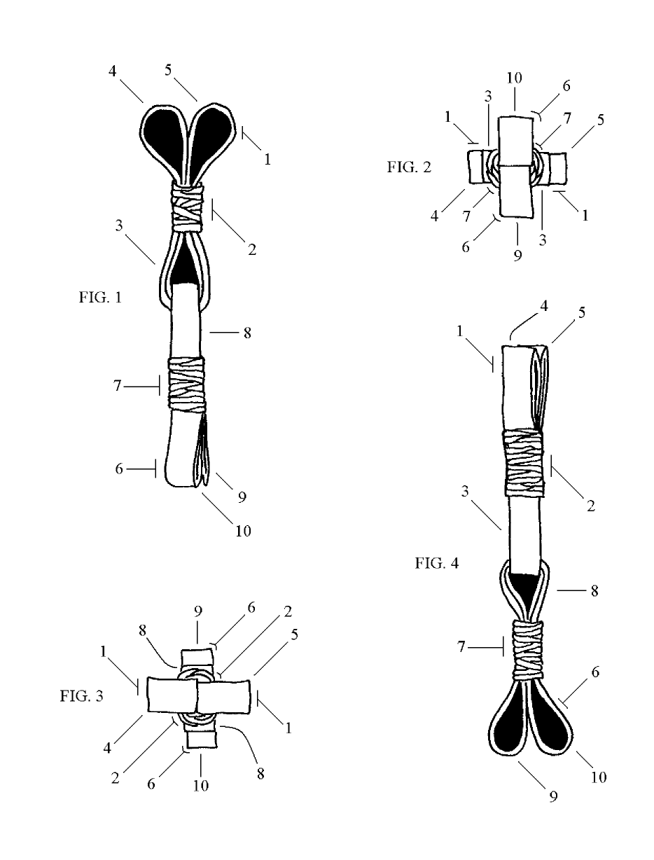

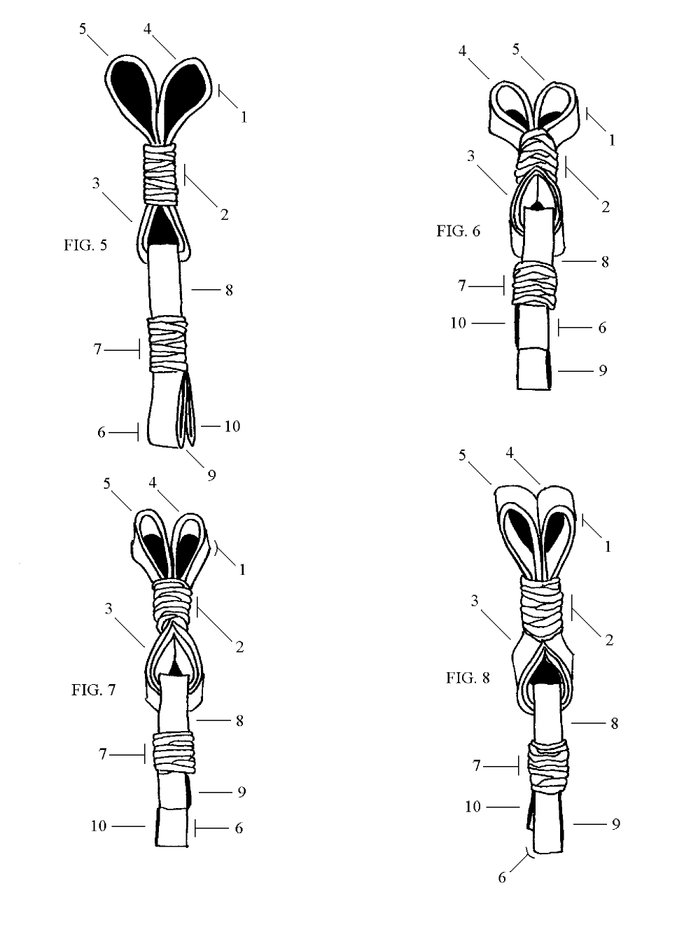

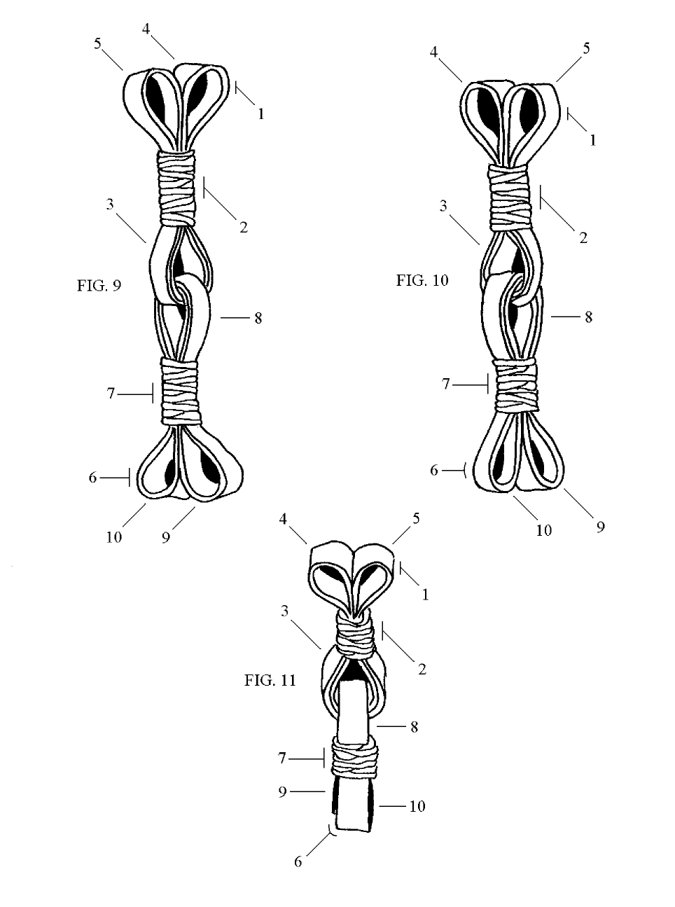

### DETAILED DESCRIPTION OF THE INVENTION

Referring to FIG. 1, a preferred embodiment of a dual coupling link for rubber band sculptures comprises two thick rubber bands 1 and 6, and two thin rubber bands 2 and 7. As described in Ser. No. 11/105,744, the thick rubber band 1 is folded onto itself across its midsection and is bound by the thin rubber band 2, thus creating coupling loops 3, 4, and 5. The rubber band 6 is then maneuvered through the coupling loop 3 and then folded onto itself and bound by rubber band 7, thus forming a new structure with coupling loops 3, 4, 5, 8, 9, and 10.

The dual coupling link for rubber band sculptures is easily extended by binding similar links at loops 3, 4, 5, 8, 9, and 10. A virtually infinite variety of rubber band sculptures may thus be constructed from said dual coupling links.

What is claimed is:

1. A dual coupling link for rubber band sculptures comprising four rubber bands, the first of which is folded onto itself across its midsection; the second of which is used to bound the first rubber band across its folded length in such a way that three loops are formed, one loop near the midsection of the first rubber band where it is folded, and two loops at either end of the first rubber band that protrude from the folded section of the first rubber band where it is bound by the second rubber band; the third of which, after being maneuvered through the loop in the first rubber band formed by its folded midsection, is then also folded onto itself in such a way that the third rubber band's folded midsection is secured to the first rubber band's folded midsection; and the fourth of which is used to bound the third rubber band across its folded length in such a way that three additional loops are formed, one loop near the folded midsection of the third rubber band, and two loops at either end of the third rubber band that protrude from the folded section of the third rubber band where it is bound by the fourth rubber band.
